(19) United States
(12) Patent Application Publication
(10) Pub. No.: US 2011/0114807 A1
(43) Pub. Date: May 19, 2011

(54) TREE TOP DECORATION HOLDER

(76) Inventor: Jonathan Rees Richardson, Holly Springs, NC (US)

(21) Appl. No.: 13/011,270

(22) Filed: Jan. 21, 2011

Related U.S. Application Data
(63) Continuation-in-part of application No. 12/254,928, filed on Oct. 21, 2008.

(51) Int. Cl. F16B 2/20

(52) U.S. Cl. 248/229.16

(57) ABSTRACT

Taught herein is an adjustable holder for a tree top decoration for use on a Christmas tree. The holder features interchangeable attachments so it can accommodate a wide range of tree top decorations.

This application is a continuation-in-part of U.S. non-provisional application Ser. No. 12/254,928 filed on Oct. 21, 2008 and is included herein in its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to an adjustable holder for tree top decoration for use on a Christmas tree or the like.

2. Description of Related Art

Decorating trees, especially evergreen trees, for the Christmas season is an old tradition of European origin that is enthusiastically embraced in our contemporary culture. Often an evergreen is placed in a prominent place in a home, place of business, or public area then decorated with lights and ornaments to become a “Christmas tree,” a popular icon for the Christmas season. Many ornaments and other decorations have deeply symbolic religious or sentimental meanings. For example, often a star or an angel is placed on the highest branch as a tree top decoration. While most ornaments are hung from the boughs of a Christmas tree, a tree top decoration typically has a conical base that fits over the upright branch that is actually the upper most extension of the tree's trunk.

Christmas tree decorations range from the simple ornaments made by children to elaborate artistic works in precious metals and bearing jewels. The art abounds with examples of ornaments going back for centuries. Likewise, the foreign and domestic patent literature teaches thousands of Christmas tree decorations and related inventions. For example, U.S. Pat. No. 6,719,251 teaches a frame system that fits over a Christmas tree to hold bows and other decorations, and US patent application 2006/0198164 teaches a tree topper decoration having a base portion releasable from an ornamental portion.

### BRIEF SUMMARY OF THE INVENTION

The present invention, a tree top decoration holder, solves the problem of adjusting a tree top decoration without altering its attachment to the tree by having the actual decoration connected through a means for holding it to an adjustable means to a section of the holder that is affixed to the top of the tree or other substantially vertical branch. In particular, the present holder facilitates changing and adjusting a tree top decoration on a Christmas tree.

An embodiment of the present invention is an adjustable Christmas tree top decorative article holder comprising:
a) an affixing means for affixing the holder to, or near to, the top of a Christmas tree comprising a clip;
b) an attaching means for attaching a decorative article to the holder comprising a clip; and
c) a means which allows the adjustment of the position of the affixing means relative to the attaching means in order to adjust the position of a decorative article attached to the attaching means comprising a flexible goose neck.

In a second embodiment, the holder has the same elements as the first embodiment but further provides that the affixing means and the attaching means are connected through a means that allows relative adjustment of the attaching means to the affixing means.

### BRIEF DESCRIPTION OF THE DRAWINGS

FIG. 1a shows a clamping device with an attachment stud.

FIG. 1b shows a supporting tube with an attachment stud.

FIG. 2a shows a ball joint between a clamping device and an attachment stud.

FIG. 2b shows a ball joint between a supporting tube and an attachment stud.

FIG. 3a illustrates a tree top decoration holder with a dome support and clamp attachment upon which a tree top decoration may rest.

FIG. 3b illustrates a holder with a scissor type squeeze tip attachment upon which a tree top decoration may rest.

FIG. 3c illustrates a holder with a conical attachment upon which a tree top decoration may rest.

FIGS. 3d and 3e exemplifies two other conical attachments for the holder. FIG. 3f presents a typical bottom view of conical attachments.

FIGS. 4a and 4b illustrates two examples of a flexible neck embodiment of the invention.

FIG. 5 is an embodiment having a squeeze type clip device for attaching to the tree a flexible neck and a squeeze type clip for attaching a decorative article.

### DETAILED DESCRIPTION OF THE INVENTION

While this invention is susceptible to embodiment in many different forms, there is shown in the drawings and will be described in detailed specific embodiments, with the understanding that the present disclosure of such embodiments is to be considered an example of the principles and not intended to limit the invention to the specific embodiments shown and described herein. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Reference throughout this document to “one embodiment,” “certain embodiments,” and “an embodiment” or similar terms means that a particular feature, structure, or characteristic described in connection with the embodiment is included in at least one embodiment of the present invention. Thus, the appearances of such phrases, or in various places throughout this specification, are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive.

As used herein the term “affixing means” refers to a portion of the device of the present invention which has a means for attaching the device to the top upright branch or other top branches of a Christmas tree. This area could be considered at or near to the top of the Christmas tree. By “means” is not meant any one particular device or method but refers to the ability of the device to attach to the top portion of the tree and in one embodiment fixedly attached to those top branch or branches. In one embodiment it could be a clip, such as a squeeze clip, in other embodiments it could attach by tying, friction, sleeves, gravity, or the like. A sleeve for slipping over the tip of the uppermost upright branch could be another embodiment of the present invention. One skilled in the art could easily in view of this disclosure understand other embodiments of affixing the device to the top area of a Christmas tree.

As used herein the term “attaching” refers to the ability of the present invention to hold or otherwise position a Christmas tree topper at a top portion of the tree. Attachment can be by gravity, friction, tying, clips (such as a squeeze clip), sleeves, or any other convenient means. The exact means may have to do with the exact shape of the Christmas tree topper, but universal type attachment means, or specific to the tree topper are both contemplated herein. One embodiment of the present invention is the device of the present invention with a Christmas decorative article removably or permanently attached to the device.

As used herein the phrase “a means which allows the adjustment of the position of the affixing means, relative to the attachment means, in order to adjust the position of a decorative article attached to the attaching means” refers to the ability of the device to position a decorative article attached to the device such that it is properly positioned on top of a Christmas tree while keeping it firmly attached to the tree, i.e. without moving the attachment means. Once the device is attached to a top area of the Christmas tree and the decorative article is attached to the attachment means, the adjustment means allows the positioning of the article to be such that it is oriented upright and not leaning in any manner. Normally, without the device, gravity or other branches dictate the positioning of a Christmas tree topper and frequently tree toppers stay in a crooked position during the holidays. With the present invention the adjustment allows the positioning of the decorative article to be moved relative to the tree until it is upright and straight. In one embodiment the device is positioned underneath the decorative article so that it is hidden from view. While an underneath connection is not necessary, in one embodiment it is so mounted. Other embodiments could have at least some portion positioned within view or outside the underneath portion of the decorative article. One skilled in the art could, in view of this disclosure, produce various means for accomplishing the desired task. In one embodiment the means is a ball that swivels. Other swivel devices could also be within the scope of the present invention. Another method for providing adjustment in yet another embodiment is a gooseneck flexible connector. A locking means could be used, such as a series of screws, that hold down the part of the device that holds the decorative article which then could be loosened and then retightened as necessary while the article is repositioned. The swivel or other repositioning device could be free moving, or in other embodiments, could lock in place once the proper positioning is achieved. It is understood that any swivel device must have enough tension that the weight of an attached article will not cause the swivel to move once positioned. Once again, a locking mechanism would allow for heavier decorative articles. In another embodiment the means could be a flexible neck that connects the tree topper holder to the tree attachment means. Flexible necks come in various lengths and types, but in general, a fairly short shaft with the ability to adjust in most directions (6 degrees of freedom) could be considered a flexible neck. Other means for creating relative positioning movement between the decorative article and the tree attachment means should be evident from the present disclosure and the cited embodiments and are considered within the scope of this invention.

As used herein “decorative articles” refers to articles designed to place on the top of a Christmas tree. Such articles would include but not be limited to stars, angels, snowflakes, Santa, 3-dimensional decorations (like balls), or other Christmas shapes. These articles are frequently called Christmas tree toppers and these types of decorative articles are considered within the scope of the present invention. They can be made of most anything, but lighter weight articles are generally the norm. For example, they can be made of wood, paper, plastic, foam materials, cloth, metals, and combinations of these, as well as other materials. Tree toppers frequently have a conical base which is designed to sit on the top of the tree by gravity. While gravity is good to keep the tree topper from falling off the tree, the arrangement of the branches and the weight of the tree topper frequently make it extraordinarily difficult, if not impossible, to position the tree topper in a perfectly upright position.

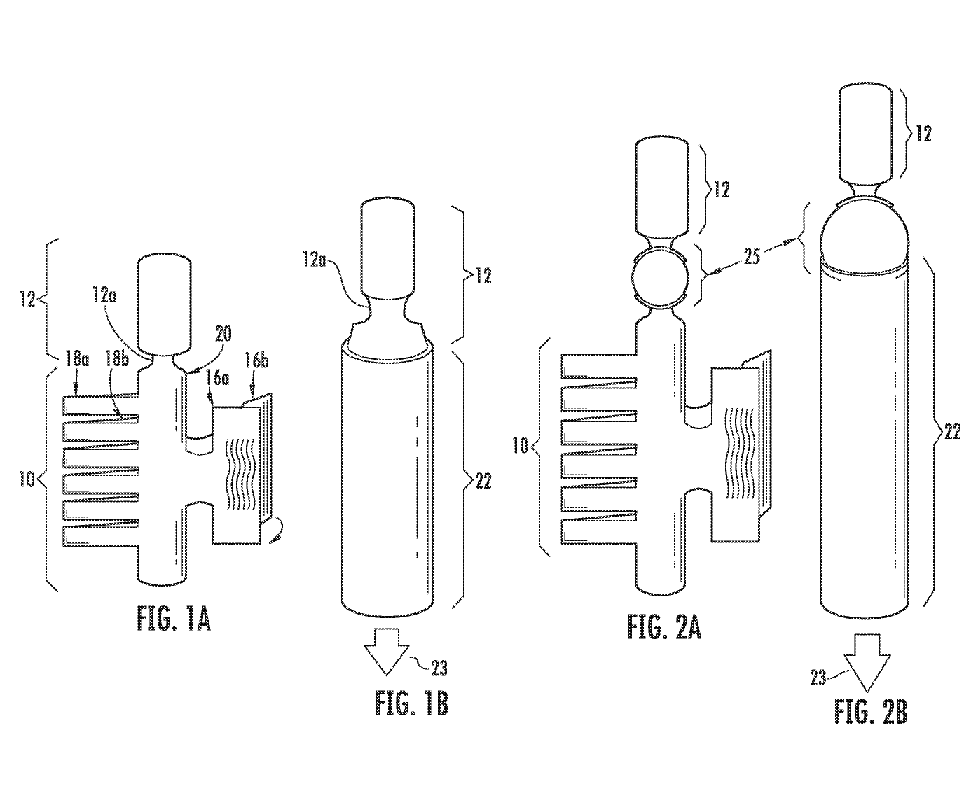

FIG. 1a shows an affixing means for holding a device of the present invention to a Christmas tree. In this embodiment, the affixing means is a clamping device 10 having an attachment stud 12 which is capable of swiveling at swivel point 12a which can act to adjust the relative position of the attachment means to the affixing means. As tabs 16a and 16b are squeezed together with a person's fingers, blade sets 18a and 18b (18b is only partially shown in FIG. 1a) separate as indicated by the arrow. Conveniently, each blade set is curved slightly inward resembling a pair of hands holding a cylindrical object. One or more springs (not shown but within the skill in the art) or functionally similar devices within the body 20 of clamping device 10 tends to force blade sets 18a and 18b together when tabs 18a and 18b are not being squeezed. With tabs 16a and 16b squeezed, blade sets 18a and 18b, now separated, are slipped around a branch at, or near, the top of the tree being decorated. As the squeezing pressure on tabs 16a and 16b is released, blade sets 18a and 18b are forced together, clamping around the tree branch and affixing clamping device 10 to the tree branch, and thus removably fixing the device to a tree. Over attachment stud 12 of clamping device 10 may be placed one of a variety of interchangeable tree top decoration holder attachments as will be explained in detail below, but the stud can then be swiveled to the desired position once installed on a Christmas tree.

Alternatively, as shown in FIG. 1b, hollow supporting tube 22 may be used in lieu of clamping device 10 from FIG. 1a to support and stabilize the hold on stud 12. Supporting tube 22, which is cylindrical or slightly conical, is slipped over an upright branch in the direction of arrow 23, such as the top branch of the tree being decorated as indicated by the arrow. As used herein, the term “top branch” refers to the upper most, upright branch that is actually an extension of the trunk of an evergreen tree, such as a pine, spruce, or fir typically used as a Christmas tree.

In another embodiment shown in FIG. 2a and FIG. 2b, stud 12 is connected to clamping device 10, or supporting tube 22, through an interfacing means that allows stud 12 to be adjustable with respect to clamping device 10, or supporting tube 22. In this embodiment, a ball joint 25 provides the desirable adjustable interface as illustrated in FIG. 2a and FIG. 2b. Thus, even if a top branch is not exactly upright, which is often the case, stud 12 can be appropriately adjusted via ball 25 to compensate as will be explained in detail below.

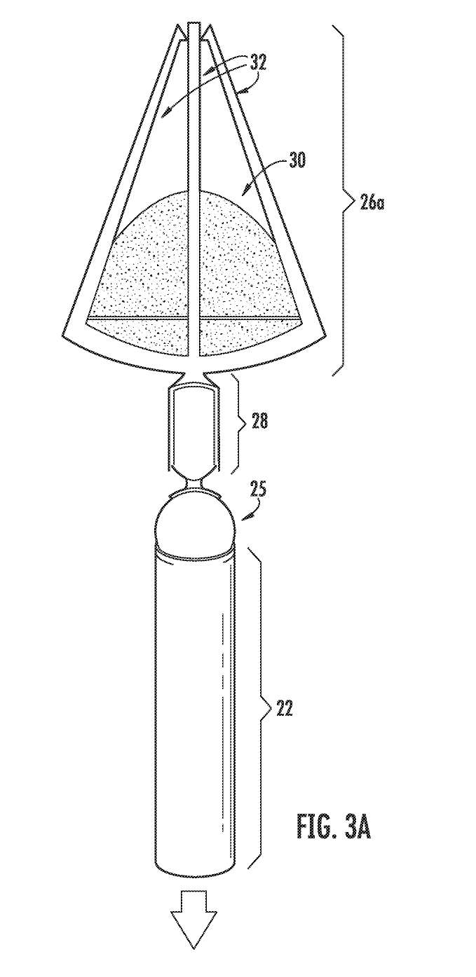

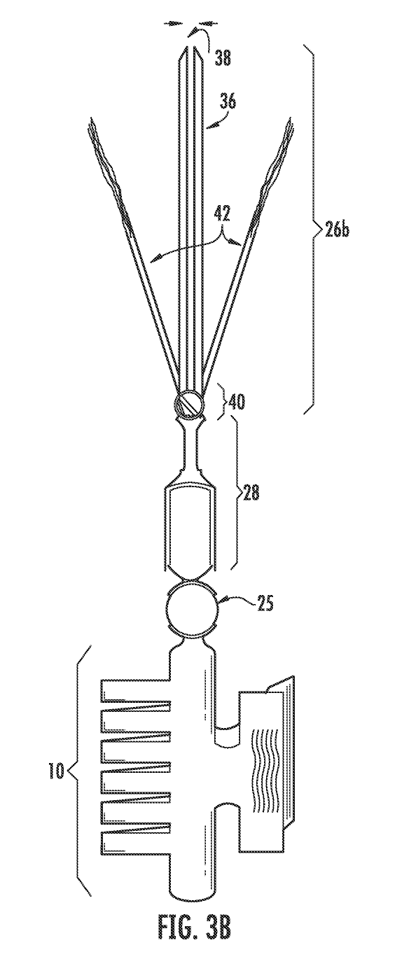

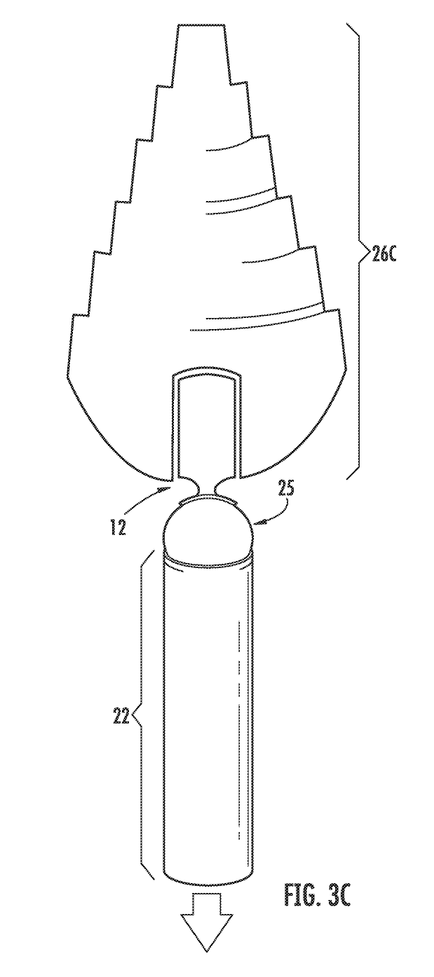

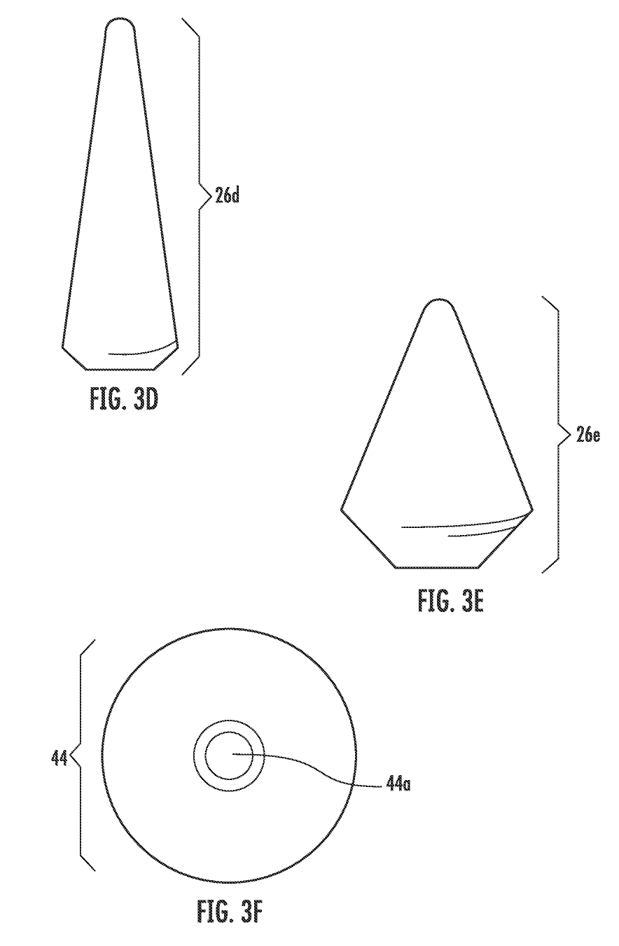

As shown in FIG. 3a-FIG. 3c, stud 12 of both clamping device 10 and supporting tube 22 may be fitted with a plurality of interchangeable attachments 26a, 26b, and 26c, respectively. Other examples of interchangeable attachments 26d and 26e are presented in FIG. 3d and FIG. 3e. Each interchangeable attachment, such as one of those exemplified by 26a-26e, has a base 28 that fits snugly over stud 12. In the case of attachment 26a (FIG. 3a), the actual tree top decoration, such as a star or figure of an angel, sits atop dome 30 and the conical base of the decorative article is held in place by arms 32. The advantage of ball joint 25 or other such swiveling means or adjustment means is evident. If attachment clamping device 10, or supporting tube 22, are tilted with respect to the vertical axis of the tree because of natural irregularities of the tree, e.g. the attachment 26a, and hence the tree top decoration, can easily be adjusted with respect to the tree, through ball joint 25, to a pleasing position.

Attachment 26b, as illustrated in FIG. 3b, exemplifies a “scissor” type action. The tree top decoration is placed over blades 36 while the blades are together in a vertical position 38. Tightening screw 40 is then adjusted so that the blades 36 may be spread apart into position 42, thus holding the tree top decoration in place. Attachment 26c (shown in FIG. 3c) and attachments 26d and 26e are substantially conically bases upon which a tree top decoration may rest as shown in FIG. 3d and FIG. 3e.

FIG. 3f presents bottom view 44 of the devices from FIG. 3d and FIG. 3e which shows the opening 44a in the bottom which is used similarly to supporting tube 22 from previous figures.

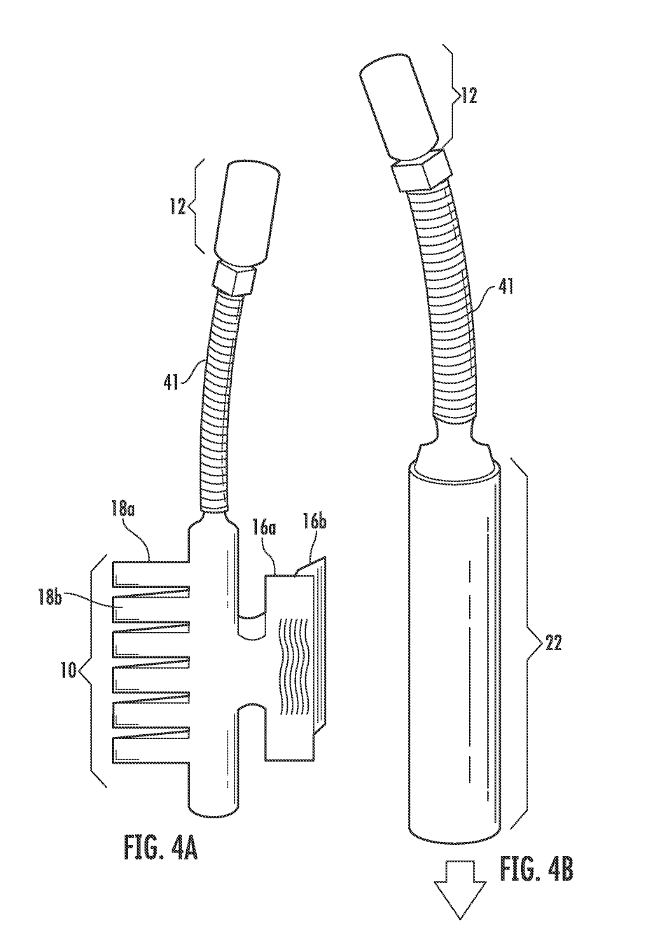

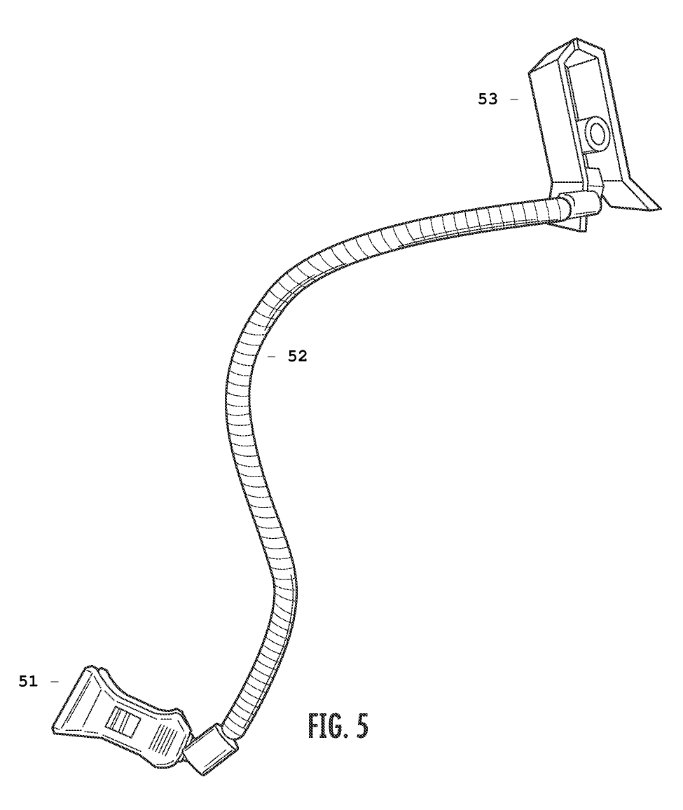

FIG. 4a and FIG. 4b represent the flexible neck or gooseneck approach to adjustment. In this view, a flexible neck 41 is shown as the adjustment means. The flexible neck 41 is a gooseneck type flexible metal type device and serves the same purposes as the other swivel devices in the present invention.

FIG. 5 is a device with a squeeze clip for both attachment to the tree and for attaching the ornament. In this view tree squeeze clip 51 attaches to the top of a tree. A flexible gooseneck 52 allows for positioning and adjusting while squeeze clip 53 is used to attach an ornament.

The holder taught herein may be fabricated from any suitable material used in the art of tree decorations such as metal, polymers, composite material, wood, and the like including combinations thereof. However, polymers with some metal components as appropriate presents a practical compromise between durability and manufacturing cost and are preferred.

What is claimed is:

1. An adjustable Christmas tree top decorative article holder comprising:
a) an affixing means for affixing the holder to, or near to, the top of a Christmas tree comprising a clip;
b) an attaching means for attaching a decorative article to the holder comprising a clip; and
c) a means which allows the adjustment of the position of the affixing means relative to the attaching means in order to adjust the position of a decorative article attached to the attaching means comprising a flexible goose neck.

2. The holder of claim 1 wherein the affixing means is a squeeze clip.

3. The holder of claim 1 wherein the attaching means is a squeeze clip.

4. The holder according to claim 1 attached to a Christmas tree wherein the holder is positioned at or near the top of the tree.

5. A holder according to claim 4 wherein a decorative Christmas article is attached to the attaching means.

6. A holder according to claim 1 wherein a decorative Christmas article is attached to the attaching means.
